(19) United States
(12) Patent Application Publication
(10) Pub. No.: US 2019/0051025 A1
(43) Pub. Date: Feb. 14, 2019

(54) DATA REDUCTION AND DISPLAY WITHOUT QUALITY LOSS

(71) Applicant: Thermo Finnigan LLC, San Jose, CA (US)

(72) Inventor: Ming LIU, Austin, TX (US)

(73) Assignee: Thermo Finnigan LLC

(21) Appl. No.: 16/054,126

(22) Filed: Aug. 3, 2018

Related U.S. Application Data
(60) Provisional application No. 62/542,680, filed on Aug. 8, 2017.

(51) Int. Cl. G06T 11/20; G06F 17/30; G01N 30/86

(52) U.S. Cl. CPC G06T 11/206; G01N 30/8651; G06F 17/3089

(57) ABSTRACT

A method for displaying a graphical trace on a display device comprises: (a) determining a number of data points, nₚ, of the trace; (b) determining a number of data-display-device pixels, nₓ; (c) partitioning the abscissa variable into nₓ equal-width bins; (d) selecting, within each bin, three data points consisting of: a data point having the least value of the variable X, a different data point of the bin having the greatest value of the variable, Y and a yet different data point having the least value of the variable Y; and (e) displaying a graphical trace of the 3nₓ selected points using an existing display, printing or plotting algorithm. Alternatively, the step (c) comprises partitioning the abscissa variable into nᵣ equal-width bins where nᵣ=(nₓ/fᵣ) and fᵣ is a settable reduce factor greater than zero.

### CROSS-REFERENCE TO RELATED APPLICATION

This application claims the benefit of the filing date, under 35 USC 119(e), of co-pending and co-owned U.S. Provisional Application 62/542,680 filed on Aug. 8, 2017, the disclosure of which is incorporated by reference herein in its entirety.

### FIELD OF THE INVENTION

The present invention relates to chromatography, mass spectrometry and combined chromatography and mass spectrometry. More particularly, the present invention relates to methods for efficient display, storage and transmission of data derived from chromatographic, mass spectrometric, and combined chromatographic and mass spectrometric experiments or analyses.

### BACKGROUND OF THE INVENTION

In chromatography, research scientists, analysts and clinicians are constantly dealing with ever-increasing amounts of data. The resulting large data set sizes and large file sizes create challenges for graphical visualization of data on screen or on paper, for storing the data and for communicating such data over networks. Without data reduction, two key problems emerge as the size of a data set increases: (1) computer memory will eventually reach its maximum capacity; (2) computer performance will gradually becoming slower and more unresponsive. Typically, in the absence of data reduction, the only option in dealing with increasing data quantity is to upgrade computer hardware with more CPU power and larger memory. Furthermore, as applications move towards distributed processing applications that include real-time transfer of information over the Internet and Internet-based applications, data visualization is mostly done using a conventional web browser whose data-display capacity may be limited as compared to traditional desktop applications. In such cases, the need for data reduction for visualization is of prime importance.

In the past, individuals have attempted to reduce data in many ways. For example, much effort has been made in attempts to determine how to discard “unimportant” data points, based on domain knowledge or knowledge of the nature of the data. However, none of these shortcuts can guarantee the quality of the data after reduction; in other words, would a graphical plot of the reduced data set convey the same information as a graph of the un-reduced data? In this regard, data reduction is simple and straightforward if one does not care much about the quality of the data after the reduction. For example, one could eliminate every second data point so as to easily reduce the amount of data by fifty percent. Such a procedure may be acceptable for some applications. However, for visualization of chromatographic and mass spectrometric data as well as for most of the applications that rely on such data, such as qualitative and quantitative data analysis applications, it is unacceptable if information gets lost after data reduction. Therefore, the major technical challenge of data reduction is how to do it without quality loss. Another factor that should be considered is the level of complexity of the data reduction algorithm. If it is too complicated, then it might not be practical because it would be too hard to implement, or it would take too much CPU time to execute.

### SUMMARY OF THE INVENTION

The algorithm described herein is able to reduce data without quality loss for visual presentation of data while also providing flexibility for applications to balance between reduction rate and data quality. The algorithm is simple, but very effective, especially when dealing with large amount of data. The larger the data size, the better the algorithm works. In fact, this algorithm can be used in any software application where a large quantity of data is generated that requires visualization on screen or on paper or that requires transmission over a network for real-time visualization at a site that is remote from where the data is stored.

Further, the algorithm is so simple that any software engineer could implement it in minutes once it is understood. In fact, it is possible to implement an operational version of the algorithm in as few as sixteen lines of code. First, a determination is made of the number of data-display-device pixels, nₓ, that occur parallel to a direction to be used as the abscissa for a graphical plot and across a portion of the display device to be used as the abscissa for the graphical plot. If the number of data points of the data that is submitted for plotting is fewer than (3×nₓ), then the drawing functions of a computer or of a computer display application or of the display device are called so as to display all of the data points of the submitted data, possibly interconnected by lines. Otherwise, the data points of the un-reduced data that is to be plotted are partitioned into bins according to their various abscissa values where the bins are of equal width in the data variable that corresponds to the abscissa. In some embodiments, each such bin corresponds a single pixel width along the abscissa of the display device (e.g., to a column of pixels). Thus, in such embodiments, a total of nₓ bins are defined. In other, alternative, embodiments, a settable “reduce factor”, fᵣ, may be defined (where fᵣ, >0) which causes the data to be plotted either more densely or more sparsely, depending on whether fᵣ, <1 or fᵣ, >1, respectively. In such embodiments, the number, nᵣ, of equal-width bins into which the data is partitioned is given by the relationship nᵣ=(nₓ/fᵣ). For each bin of data points, generally only three points of the bin are selected for display: (a) the data point of the bin having the least value of the variable corresponding to the abscissa; (b) a data point of the bin, other than the previously selected data point, having the greatest value of the variable corresponding to the ordinate; and (c) a data point of the bin, other than the previously two selected data points, having the least value of the variable corresponding to the ordinate. Finally, the drawing functions of the computer, computer display application, or display device are called so as to display the selected data points of all of the bins, the data points possibly interconnected by lines. Note that, in this document, the term “computer display screen” is used in a broad sense to encompass any form of electronic visual display such as a computer monitor of any type or a liquid crystal, plasma, or light-emitting diode display of a laptop, notebook or tablet computer or of a mobile phone.

### BRIEF DESCRIPTION OF THE DRAWINGS

To further clarify the above and other advantages and features of the present disclosure, a more particular description of the disclosure will be rendered by reference to specific embodiments thereof, which are illustrated in the appended drawings. It is appreciated that these drawings depict only illustrated embodiments of the disclosure and are therefore not to be considered limiting of its scope. Accordingly, the disclosure will be described and explained with additional specificity and detail through the use of the accompanying drawings, not necessarily drawn to scale, in which:

FIG. 1 is a zoomed-in presentation of data points within a pixel of digital display.

FIG. 2 is a plot of chromatography data with 12,344 points reduced by 53.0% to 5,796 points using a reduce factor of 0.5 for a display area of 1400×600 pixels without any loss of quality.

FIG. 3 is a plot of chromatography data with 108,301 points reduced by 92.5% to 8,113 points using a reduce factor of 0.5 for a display area of 1400×600 pixels without any loss of quality.

FIG. 4 is a plot of chromatography data with 70,843 points reduced by 89.7% to 7,272 points for a display area of 1400×600 pixels with a reduce factor of 0.5 without any loss of quality.

FIG. 5. is a plot of the same data as displayed in FIG. 4, except that a higher reduce factor of 0.8 is applied.

FIG. 6. is a plot of the same data as displayed in FIG. 4 and FIG. 5, except that a higher reduce factor of 1 is applied.

FIG. 7. is a plot of the same data as displayed in FIGS. 4 to 6, except that a higher reduce factor of 2 is applied.

FIG. 8. is a plot of the same data as displayed in FIGS. 4 to 7, except that a higher reduce factor of 5 is applied.

FIG. 9A is a schematic diagram of a local network system including a mass spectrometer, computer-readable data storage and data display and/or printing/plotting devices upon which methods in accordance with the present teachings may be practiced.

FIG. 9B is a schematic diagram of a distributed networked system upon which methods in accordance with the present teachings may be practiced, the network system including a mass spectrometer at a first site, computer-readable data storage and processing apparatus at a centralized site and data display and/or printing/plotting devices at a different site.

FIG. 10 is a graphical example of the plotting of data points using different reduce factors, fᵣ.

### DETAILED DESCRIPTION

In a digital display like a computer screen (or paper if printed or plotted), regardless of the amount of data points, only a limited amount of data may be shown, as determined by the number of display pixels. All of the extra data points simply overlap each other and do not bring any useful information to user. Despite the overlap, conventional display programs and applications will attempt to plot all of the data, thereby needlessly expending processor time and slowing any updates of the display. Further, if the display is located remotely relative to the source of the data, then the transmission of the un-necessary extra data may needlessly delay or slow the transmission. Therefore, the question arises as to how these extra points be removed without losing any graphical quality.

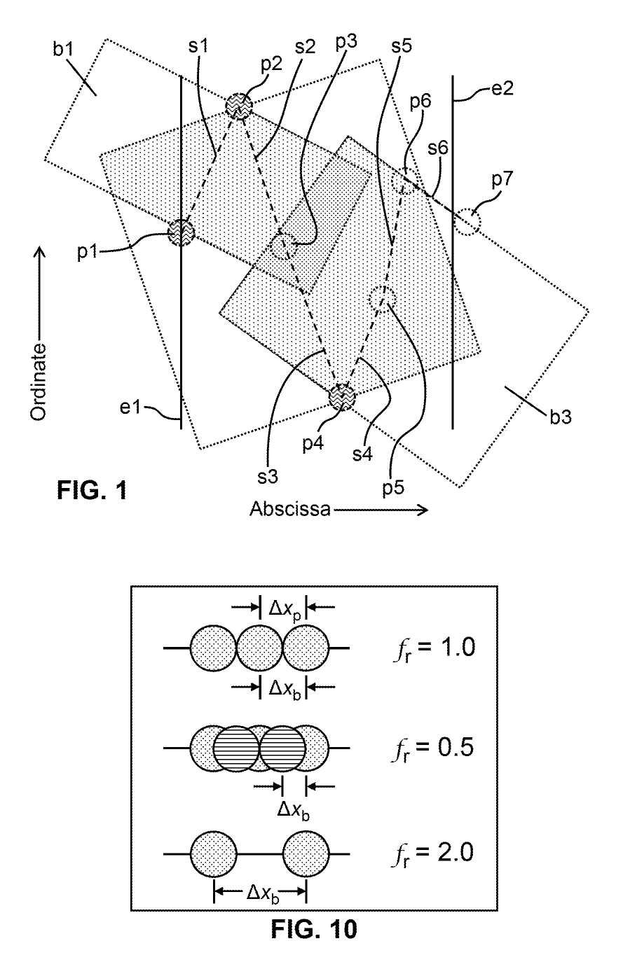

The present inventor has observed that, as a general principal, regardless of how many data points are provided in a data set submitted for display within a range of pixels, at most three points per pixel width are required to accurately represent the information in a graph considered in terms of x-y Cartesian coordinates: the first (initial) point having the least x-value, the “highest” point having the greatest y-value, and the “lowest” point having the least y-value. This concept is illustrated in FIG. 1. The two vertical black lines, e1 and e2, represent a zoomed-in depiction of the width of a pixel. For this example, assume that there are six different data points, p1-p6, which plot at between the x-value (abscissa value) of e1 and the x-value of e2. Without a reduction in the quantity of data, conventional computer plotting algorithms will attempt to draw five hypothetical straight lines, s1-s5, connecting every data point that plots within the pixel to the next data point in sequence and then a sixth line, s6, connecting the last point, p6, that plots within the pixel to the first point in sequence, p7, whose abscissa value is greater than that represented by edge, e2. However, because the width of a drawn-out line at the scope of a pixel (represented by shaded boxes, b1-b3) is so thick, this would lead to much line overlapping and, consequently, unnecessary data processing.

To solve this issue, the inventor has recognized that only the three shaded data points (the first data point which corresponds to the least abscissa value of the six data points, the data point corresponding to the greatest ordinate value out of the six data points, and the data point corresponding to the least ordinate value, out of the six data points) are required to represent the distribution of data within the given pixel range. In the hypothetical example shown in FIG. 1, these three data points are the points p1, p2 and p4. Thus, with this choice of three data points that are selected out of six, the number of lines that the computer needs to attempt to draw in the vicinity of the pixel bounded by edges e1 and e2 is reduced from five to just two. Note that a third line will be drawn from the last selected data point (p4 in this case) to the first point, p7, of the next pixel. Then, following the same procedure, an additional two data points (not shown) are selected within that next pixel. This data reduction technique would reduce unnecessary overlapping and, at the same time, provide an accurate presentation of the data within a particular pixel range.

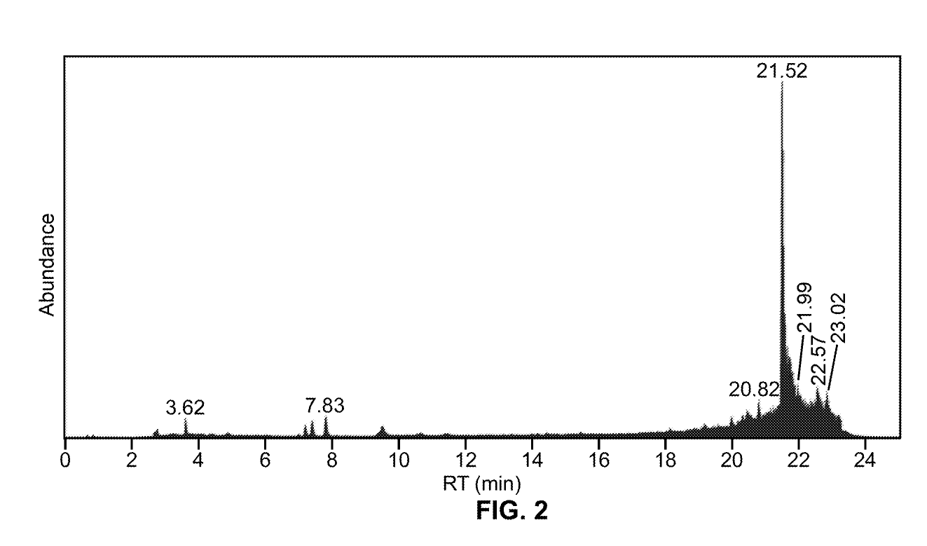

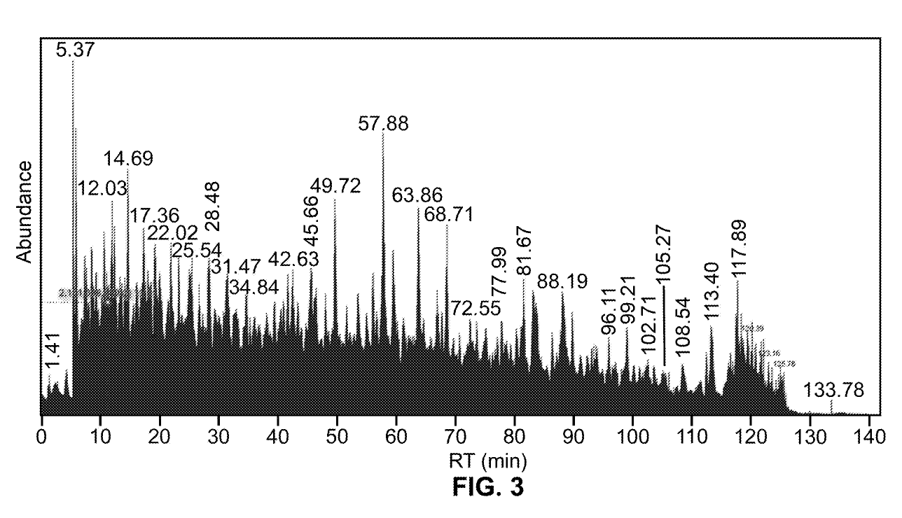

The reduction rate depends on the amount of data and size of the display. The more data that is required to be plotted on a monitor screen or printed within a region of paper and the smaller the display, the higher the reduction rate will be. This can be demonstrated by observation of the graphs depicted in FIG. 2 and FIG. 3. The raw data of the graph of FIG. 2 has total of 12,344 points but, for plotting purposes, this number of points is reduced by 53.0% in accordance with a method of the present teachings. Similarly, the raw data of the graph of FIG. 3 has a total of 108,301 points but, for plotting purposes, this number of points is reduced by 92.5% in accordance with a method of the present teachings. In both cases, a user would not discern any differences on the screen when toggling between the a plot of the reduced data and a plot of the original un-reduced data. Without such data reduction, commonly employed Internet web browser applications would start showing difficulties when dealing with more than 50,000 data points in a graph (this limit may vary widely depending on various factors).

The operation of the novel algorithm may be described as follows. First, a determination is made of the number of data-display-device pixels, nₓ, that occur parallel to a direction to be used as the abscissa for a graphical plot and across a portion of the display device to be used as the abscissa for the graphical plot. If the number of data points of the data that is submitted for plotting is fewer than (3×nₓ), then the drawing functions of a computer or of a computer display application or of the display device are called so as to display all of the data points of the submitted data, possibly interconnected by lines similar to the dashed lines shown in FIG. 1. Otherwise, the data points of the un-reduced data that is to be plotted are partitioned into nₓ bins according to their various abscissa values, where the nₓ bins are of equal width in the data variable that corresponds to the abscissa. Thus, each bin corresponds a single pixel width on the display device. For each bin of data points, only three points of the bin are selected for display: (a) the data point of the bin having the least value of the variable corresponding to the abscissa; (b) a data point of the bin, other than the previously selected data point, having the greatest value of the variable corresponding to the ordinate; and (c) a data point of the bin, other than the previously two selected data points, having the least value of the variable corresponding to the ordinate. Then, the drawing functions of the computer, computer display application, or display device are called so as to display only the selected data points of all of the bins, the data points possibly interconnected by lines. However, if two or more of the selected points plot at the same location, then computing time may be saved by only calling the appropriate point-plotting routine once.

With reference once again to FIG. 1, execution of the algorithmic steps described above will lead to the selection of the points p1, p2 and p4, within the bin corresponding to the pixel width between vertical lines e1 and e2 as well as the point p7 within the subsequent bin (that corresponds to the next pixel). If lines are to be plotted also, then plotting or display routines will be called to plot a first line connecting points p1 and p2, a second line connecting lines points p2 and p4 and a third line connecting points p4 and p7. Because the vertical lines e1 and e2 in FIG. 1 indicate the left and right edges of a vertical column of display pixels, the first two of these lines will be simple vertical lines superimposed upon one another (according to this particular example) and the third such line may be vertical or may be inclined.

Additionally, the novel algorithm may include a settable reduction parameter (indicated as the “reduce factor”, fᵣ, in the descriptions of the figures above), to balance the quality of the graph and the reduction rate. Greater values of the reduce factor mean that more data points will be eliminated from the plot.

FIG. 10 provides a graphical example of how the changing reduce factor, fᵣ, affects the plotting of points. In the prior description of FIG. 1, the separation of the vertical lines e1 and e2 was described as corresponding to the width of a pixel, taken along the direction of the abscissa. Using this definition, the determination of the bin width used to partition the data points was described as corresponding to the number of data points that would plot between the lines e1 and e2 when the data was scaled to the size of the available plotting area. More broadly, the introduction of the reduce factor, fᵣ, which, for calculation purposes, is a number that is greater than zero, relaxes the definition of the positions of the lines so that the separation between them may be any proportion or multiple of the hardware pixel width. Subsequently, the calculated bin sizes are chosen to correspond to this relaxed definition. In some embodiments, a reduce factor setting of zero (for example, as input to the algorithm by a user or as read by a data file) may be interpreted by the algorithm as meaning that no data reduction is to take place.

For example, in FIG. 10, the centers of the circles represent the abscissa positions (for example, positions projected onto the x-axis) of plotted points and the diameters of the circles represent pixel widths, Δxₚ. With a reduce factor, fᵣ, of 1.0, the separation between each point, which is equivalent to bin width, Δx_{b}, is just a pixel size (i.e., Δxₚ), as previously described and as illustrated in the upper row of circles in FIG. 10. If a straight line between points is plotted, using a reduce factor of 1.0, no visible spaces will be left unfilled. However, if the line is not straight, it may then be necessary to have overlapping points and, therefore, a greater density of points per pixel (corresponding to a narrower bin width, Δx_{b}), to ensure that there is no gap in-between the points. Setting fᵣ to 0.5 (middle row), there is then an overlap of 50% which aids in eliminating the gaps between points. Similarly, Setting fᵣ to 2.0 (lower row), every other pixel is skipped. Operationally, if nₓ represents the number of pixels along the display dimension corresponding to the abscissa that are to be used to display a data trace, then the number, nᵣ, of equal-width bins into which the data is partitioned in accordance with the present teachings is given by the relationship nᵣ=(nₓ/fᵣ).

When a reduce factor that is greater than 1.0 is employed, it may be preferable to modify the previously described algorithm steps to ensure that there are no gaps in the displayed or plotted data. Thus, it may be preferable to ensure that at least one point is plotted for every pixel width taken along the abscissa of the display or plot (in other words, at least one point for every vertical column of pixels, assuming the pixels are arranged in a rectilinear grid). This may be accomplished by drawing a line between points separated by a greater-than-one-pixel gap or by simply replicating data from the neighboring plotted points.

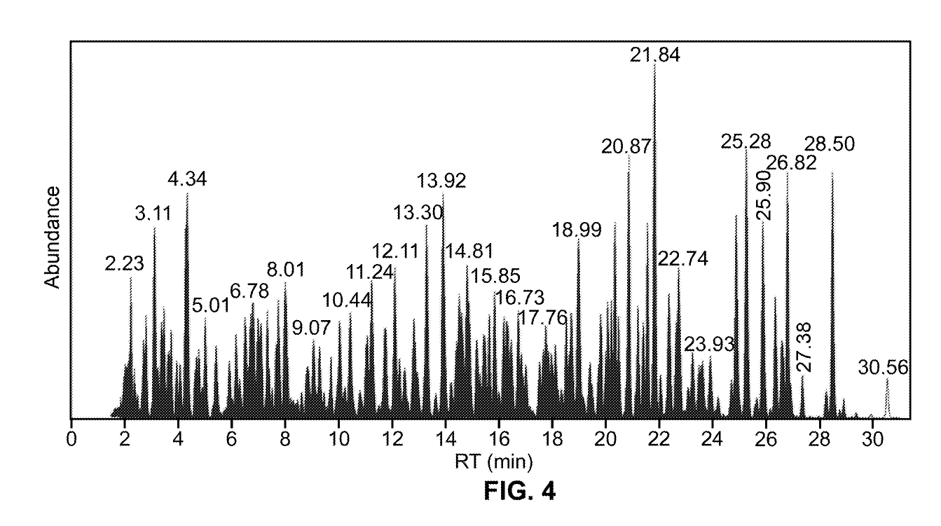

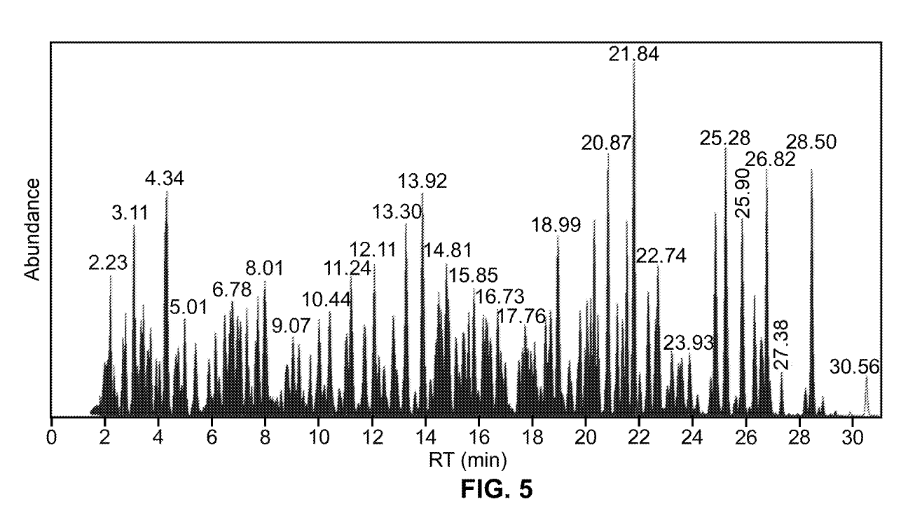

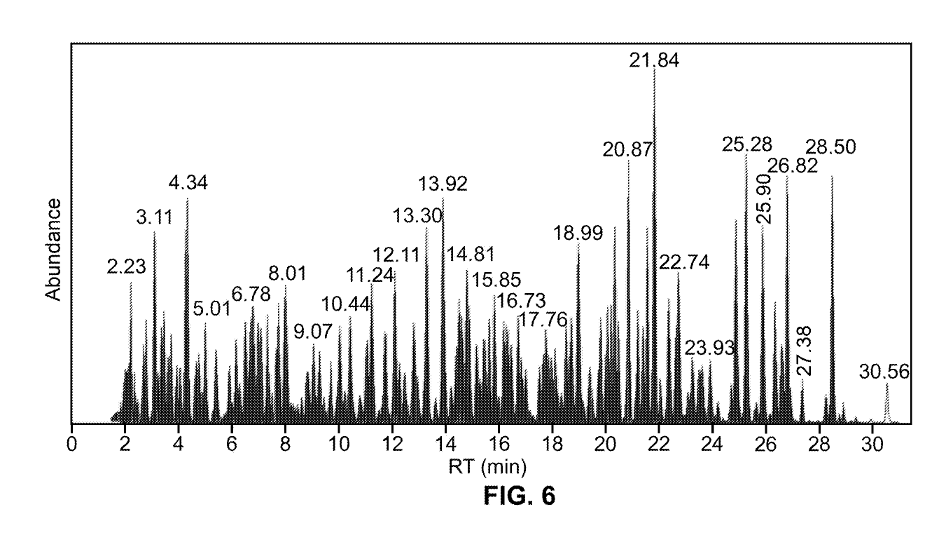

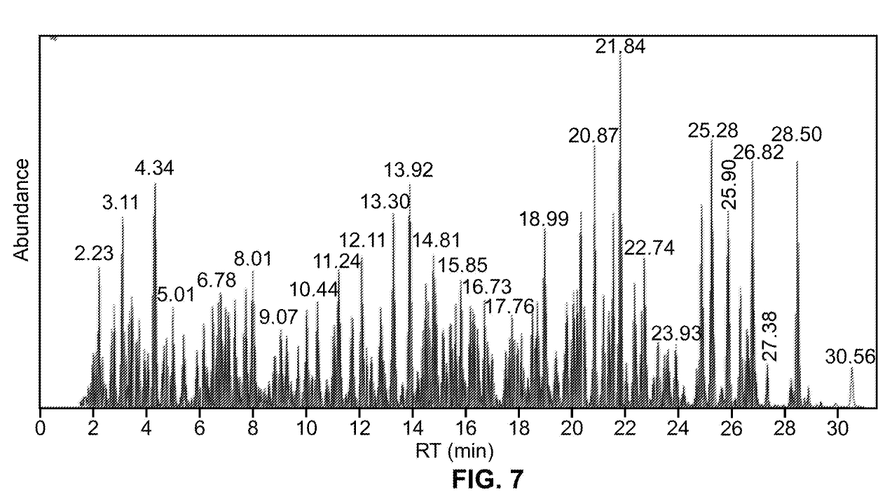

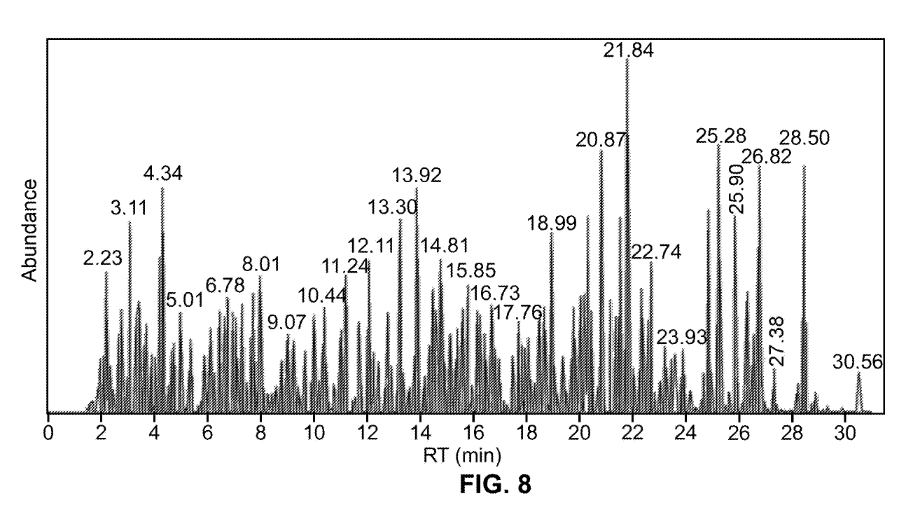

The five graphs depicted in FIGS. 4-8 demonstrate the effects of changing the reduce factor parameter on different plots of a single set of original data. Based on the inventor's observations, a value of fᵣ between 0.5 and 0.8 would cover most cases without loss of any important graphical detail. As is easily seen, the first two graphs (FIGS. 4 and 5), with reduce factors 0.5 and 0.8, respectively, do not exhibit any discernable visual difference, despite the fact that there is an additional 3.7% reduction in the plotted data of FIG. 5. However, starting with the third graph (FIG. 6), there are larger gaps between peaks and, in FIG. 6, some differences in very minor details, as there is a 94.7% reduction in the number of data points. Compared to prior graphs (FIGS. 4-6), the visual difference, relative to the plot of un-reduced data, becomes obvious in FIG. 7. However, even with a 97.3% reduction in the number of data points, this graph still maintains all the major feature of data (i.e., the peaks). Finally, the graph in FIG. 8 is visually quite different to all previous graphs of the same data set because only one percent of original data points are retained (i.e. 99% discarded). Nonetheless, all the major peaks are still present, thereby demonstrating the clear strength of this algorithm.

The accompanying graphs also demonstrate another important feature of the presently-taught data reduction algorithm in that it always preserves the most important characteristics of the data sample, even as more data points are excluded from a plot by using a higher reduce factor. In the last graph (FIG. 8), the data is reduced by 98.9%, one can still observe all the major peaks. This fact is important because, in some situations, it might be desirable to have more data reduced at the cost of losing some minor details (but never major ones) of the graph or vice versa.

With this data reduction algorithm, users would be able to see visualized data (e.g. in graph) on screen or paper, no matter how large the data set is, without encountering loss of information or computer failures. The more data that is provided, the more applicable this algorithm becomes.

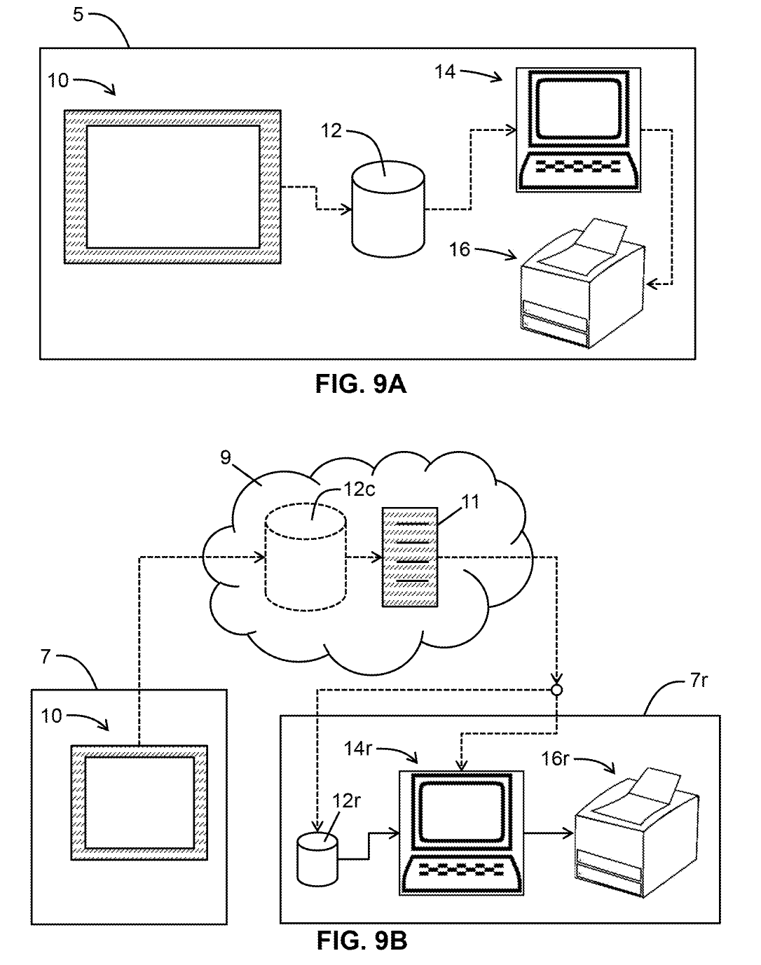

FIGS. 9A-9B are schematic diagrams of two different exemplary networked systems upon which methods in accordance with the present teachings may be practiced. For example FIG. 9A schematically depicts a local network system including an analytical data acquisition device 10, a computer-readable data storage device 12 and one or more computer systems 14 (including data display) and, optionally, one or more printing or plotting devices 16, all of which are networked together at a single “site” 5. The site 5 may consist of a single laboratory or room, or may comprise a group of laboratories or rooms, or may consist of a single building, or may comprise a group of buildings comprising a campus.

The analytical data acquisition device 10 at the site 5 comprises a chromatograph that includes a detector that acquires data pertaining to certain properties of substances that are fractionated by the chromatograph. For example, the detector may comprise, without limitation, a mass spectrometer, an infrared absorbance detector, a fluorescence detector, a Raman detector, etc. The data acquired by the detector portion of the device 10 may be sent directly to the computer with its display 14 for immediate real-time display (i.e., plotting) of aspects of the data as it is acquired. For example, if the detector is a mass spectrometer, the real-time display may continuously update itself several times each second by plotting a new most-recently acquired mass spectrum at each update. Each such mass spectrum may comprise several thousand data points. Alternatively or concurrently, the acquired data may be stored on the computer-readable data storage device 12. The acquired data that is stored on the computer-readable data storage device 12 may comprise a chromatogram comprising several thousand data points, each data point representing an output signal acquired by the detector at a certain time. The stored chromatograph data or stored mass spectral data may be saved for later display (i.e., plotting) on a computer display or for printing/plotting on a printer.

The data reduction and display techniques of the present teachings may be advantageously employed to facilitate rapid update of a display that is constantly changing, in real time, in order to display the most recently acquired data. In such a situation, the novel data display techniques taught herein may maintain synchronization with the data collection, even if a user changes the scaling of the display during the real-time data acquisition. Alternatively, the data display techniques of the present teachings may be advantageously employed when previously acquired data is read from the computer-readable data storage device 12 by the computer 14 for either display on a monitor of plotting on a printer or plotter device 16.

FIG. 9B is a schematic diagram of a distributed networked system upon which methods in accordance with the present teachings may be practiced, the network system including a first site 7 having a data acquisition device 10 having a chromatograph; one or more remote second sites 7r, each having a co-located computer-readable data storage device 12r and one or more computers 14r (including associated displays) and, optionally, one or more printing or plotting devices 16r; and a centralized computing site 9 having computer-readable data storage apparatus 12c and computer processing apparatus 11, wherein the centralized computing site 9 is in network communication with both the first site 7 and the one or more second sites 7r but the various first and second sites are not necessarily in direct communication with one another. In the networked system illustrated in FIG. 9B, the data acquisition device 10 transmits, through the network connections, all acquired data (non-reduced) to the computer-readable data storage apparatus 12c of the centralized computing site 9. Preferably, the computer-readable data storage apparatus 12c comprises sufficient storage capacity for permanent or long-term archival storage of all data acquired by the acquisition device 10 in non-reduced form.

The data reduction and display techniques of the present teachings may be advantageously employed in several alternative ways when employed within the networked system illustrated in FIG. 9B. In one such application, the techniques of the present teachings may be implemented on and executed on the computer processing apparatus 11 of the centralized computing site 9, whereby the presently-taught techniques are employed to reduce the data prior to the transmission of the reduced data to one or more second sites 7r for immediate display, printing or plotting thereat. In this case, the computer processing apparatus 11 reads the original (non-reduced) data from the computer-readable data storage apparatus 12c and reduces the data, in accordance with the present teachings, to facilitate transmission over the network. When a user at the remote site 7r requests for display of a certain portion of the data at a certain scale, such information is sent from the computer 14r at the remote site to the processing apparatus 11 of the centralized computing site so that the data may be reduced appropriately for transmission over the network. The archived original data stored on the computer-readable data storage apparatus 12c is not altered. In an alternative application of the methods of the present teachings, certain selected data files may be transmitted from the centralized computer-readable data storage 12c to the remote local data storage device 12r in their original un-reduced format for temporary storage thereat. The methods of the present teaching may then be executed on the local remote computer 14r for efficient display, printing or plotting at the site 7r. In a further alternative application of the methods of the present teachings, certain selected data files may be first reduced at the centralized computing site 9 (while maintaining the archived files in their original, un-reduced form) and then transmitted, in reduced form, from the centralized computer-readable data storage 12c to the remote local data storage device 12r for storage thereat. Display, printing and plotting of the locally-stored reduced files may then be accomplished at the remote site 7r using conventional display, printing or plotting programs.

What is claimed is:

1. A method for displaying, printing or plotting a graphical trace on a display medium, comprising:
(a) determining a number of data points, nₚ, of the graphical trace;
(b) determining a number of data-display-device pixels, nₓ, that occur parallel to a direction of the display medium and disposed along a portion of the display medium to be used as an abscissa for the graphical trace;
(c) if (nₚ≤3nₓ), displaying a graphical trace of the nₚ points on the display medium using an existing display, printing or plotting algorithm; and
(d) otherwise, performing the steps of:
(d1) partitioning the variable, X, to be used as an abscissa for the graphical trace into nₓ equal-width bins and assigning each of the nₚ data points to a one of the bins in accordance with a respective value of X associated with the data point;
(d2) selecting, within each bin, three data points consisting of: (1) a data point of the bin having the least value, of the data points assigned to the bin, of the variable X, (2) a data point of the bin, other than the previously selected data point, having the greatest value, of the data points assigned to the bin, of the variable, Y, to be used as an ordinate of the graphical trace and (3) a data point of the bin, other than the previously two selected data points, having the least value, of the data points assigned to the bin, of the variable Y; and
(d3) displaying a graphical trace of the 3nₓ selected points using an existing display, printing or plotting algorithm.

2. A method as recited in claim 1, wherein the display medium is a computer display screen and the existing display, printing or plotting algorithm is a web browser program.

3. A method as recited in claim 1 further comprising, after the selecting step (d2) and prior to the displaying step (d3), transmitting information pertaining to X and Y values of each respective selected data point to the existing display, printing or plotting algorithm over the Internet.

4. A method as recited in claim 1, wherein the data points are received from a mass spectrometer or a chromatograph.

5. A method for displaying, printing or plotting a graphical trace on a display medium, comprising:
(a) determining a number of data points, nₚ, of the graphical trace;
(b) determining a number of data-display-device pixels, nₓ, that occur parallel to a direction of the display medium and disposed along a portion of the display medium to be used as an abscissa for the graphical trace;
(c) setting a numerical value of a reduce factor, fᵣ;
(d) partitioning the variable, X, to be used as an abscissa for the graphical trace into nᵣ equal-width bins, where nᵣ=(nₓ/fᵣ) and assigning each of the nₚ data points to a one of the bins in accordance with a respective value of X associated with the data point;
(e) selecting, within each bin, three data points consisting of: (1) a data point of the bin having the least value, of the data points assigned to the bin, of the variable X, (2) a data point of the bin, other than the previously selected data point, having the greatest value, of the data points assigned to the bin, of the variable, Y, to be used as an ordinate of the graphical trace and (3) a data point of the bin, other than the previously two selected data points, having the least value, of the data points assigned to the bin, of the variable Y; and
(f) displaying a graphical trace of the 3nᵣ selected points using an existing display, printing or plotting algorithm.

6. A method as recited in claim 5, wherein the display medium is a computer display screen and the existing display, printing or plotting algorithm is a web browser program.

7. A method as recited in claim 5 further comprising, after the selecting step (e) and prior to the displaying step (f), transmitting information pertaining to X and Y values of each respective selected data point to the existing display, printing or plotting algorithm over the Internet.

8. A method as recited in claim 5, wherein the data points are received from a mass spectrometer or a chromatograph.
